(19) United States
(12) Patent Application Publication
(10) Pub. No.: US 2025/0091016 A1
(43) Pub. Date: Mar. 20, 2025

(54) POLYETHERSULFONE MEMBRANES CONTAINING SULFONATED GRAPHENE OXIDE AS SUPPORT FOR AIR-DEHUMIDIFICATION MEMBRANES

(71) Applicant: Qatar Foundation for Education, Science and Community Development, Doha (QA)

(72) Inventors: Ahmed Abdala, Doha (QA); Abdul Rehman, Doha (QA); Ahmed Mohamed, Doha (QA); Hafsa Ashraf, Doha (QA)

(21) Appl. No.: 18/827,032

(22) Filed: Sep. 6, 2024

Related U.S. Application Data
(60) Provisional application No. 63/539,032, filed on Sep. 18, 2023.

(51) Int. Cl. B01D 67/00; B01D 53/26; B01D 69/14; B01D 71/02; B01D 71/68

(52) U.S. Cl. CPC B01D 67/00793; B01D 53/268; B01D 69/148; B01D 71/0211; B01D 71/68; B01D 2257/80; B01D 2258/06; B01D 2323/02

(57) ABSTRACT

A process to fabricate a polyethersulfone membrane is provided. The process includes providing polyethersulfone and sulfonated graphene oxide; forming a solution including polyethersulfone, polyvinylpyrrolidone, and sulfonated graphene oxide; processing the solution to provide the polyethersulfone microfiltration of ultrafiltration membrane. A polyethersulfone membrane and use thereof are also provided, wherein the polyethersulfone membrane includes polyethersulfone and sulfonated graphene oxide.

### PRIORITY CLAIM AND CROSS-REFERENCE TO RELATED APPLICATIONS

The present application claims the benefit of U.S. Provisional Application No. 63/539,032 filed Sep. 18, 2023, which is incorporated herein by reference in its entirety.

### BACKGROUND

Approximately 5 billion people reside in regions with significant cooling demands, but only one-third have air conditioning, primarily in developed nations. By 2050, climate change and population growth will elevate this figure to 7 billion, with electricity consumption for space cooling approaching 5,200 TWh. This demand could decrease by over 50% by enhancing air conditioner efficiency and utilizing passive cooling measures in buildings. The Kigali amendment aims to reduce the production and consumption of hydrofluorocarbons (“HFCs”), which are potent greenhouse gases used in various applications, by establishing quantitative goals. It strives to achieve an 80-85% reduction in HFC consumption by 2047, compared to the peak levels of the late 2010s. The schedule for phasedown varies based on a country's level of development.

Exploration of alternative air-cooling technologies, such as low-global warming alternatives to HFCs and evaporative cooling coupled with membrane dehumidification, is necessary to limit the increase in global temperature. The use of evaporative cooling coupled with a membrane air-dehumidification approach is energy efficient and requires high membrane water vapor to air selectivity and water vapor permeance for maximum efficiency. Commercial practices require limiting the membrane size to 10 m₂ for a 3-ton cooling unit, which means membranes with water vapor water vapor permeance (WVP) of ˜10,000 GPU.

Polyether sulfone (PES) membranes are widely used as a support for air dehumidification membranes because of their superior mechanical properties, high chemical resistance, wide range of pore sizes, and ease of coating. The sulfone group in PES enhances its hydrophilicity by increasing the polymer's overall polarity with two highly polar oxygen atoms. However, the overall WVP of air dehumidification membranes is limited by the WVP of the PES support membranes, which is ˜7000 GPU. One solution to enhance the air-dehumidification membrane permeance is to use porous metallic or ceramic supports, such as Ni or Alumina, which have higher permeances. Yet, forming thin-film composite (“TFC”) membranes on alumina supports and achieving good adhesion between the TFC layer and the support poses challenges due to the high surface energy of alumina. While nickel and alumina-based supports tend to have higher WVP than PES, they are also more expensive, with an average price range of $500-3000 per square meter, compared to $20-200 per square meter for polymeric membranes.

Further, polymeric membranes supported on porous ultrafiltration (“UF”) membranes are the most promising air dehumidification membranes. Air cooling based on membrane dehumidification requires extremely high WVP of more than 10,000 GPU and selectively >1000. The performance of current polymeric air-dehumidification membranes does not meet that WVP because their performance is limited by WVP of the porous support that provides mechanical support for air-dehumidification membranes. Nonetheless, the WVP of porous polymeric supports is <10,000 GPU and the WVP of the active membrane will be limited to ˜5,000 GPU. Additionally, the performance of these membranes in terms of WVP is dictated by not only the WVP of the thin active, dense layer but also the WVP of the thick, porous support layer. Nonetheless, optimization of the WVP of the porous support is usually neglected.

As such, there is a need for enhancing the WVP of PES membranes for use as a support for air-dehumidification membranes.

### SUMMARY

The present disclosure generally relates a mixed matrix PES membranes containing sulfonated graphene oxide (SGO) and a method of manufacture and use. For example, the present disclosure is directed to enhancing the WVP of microfiltration (“MF”) and ultrafiltration (“UF”) polyether PES membranes via the fabrication of mixed matrix membranes (MMM) containing SGO, a functionalized graphene oxide. Incorporating small concentrations of the very hydrophilic SGO into the PES matrix has led to substantial enhancement in the hydrophilicity of the PES-SGO MMM leading to significant enhancement of the WVP of the PES membranes. For example, the WVP of the MMM can be significantly increased, such as from 13,400 to 24,800 GPU for MF membranes and from 13,100 to 20,800 to GPU for the UF membranes, corresponding to 85% and 59% increase in WVP for the MF and UF membranes, respectively. These results open the door, for example, for the development of high-performance TFC membranes for air dehumidification applications.

According to one non-limiting aspect of the present disclosure, a process to fabricate a PES membrane is provided. The process includes providing PES and SGO; forming a solution including PES and SGO; and processing the solution to provide the PES membrane.

In another embodiment, a PES membrane is provided and includes PES and SGO.

The present disclosure includes, for example, the following features: (1) the selection of graphene oxide (GO) prepared by the known Tour method, which has better hydrophilicity than GO prepared by the conventional Hummers' method; (2) the selection of sulfonic acid functionalization of GO that results in significant enhancement in hydrophilicity of GO and improving the compatibility of GO with PES; (3) the fabrication of a PES UF MMM containing small concentrations of SGO (0.05-1%); (4) the use of SGO, a pivotal departure from GO, reduced graphene oxide (rGO), or amine-functionalized graphene oxide. The present disclosure is directed to increasing the WVP of the PES membrane, such as up to ˜25,000 GPU, according to an embodiment.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

Features and advantages of the present disclosure, including a PES membrane and a process to fabricate a PES membrane, described herein may be better understood by reference to the accompanying drawings in which:

FIG. 1 illustrates a graph depicting the membrane area requirement as a function of WVP, according to an example embodiment of the present disclosure.

FIGS. 2A-2B illustrate (A) a graph depicting the selectivity versus the WVP of different supported membranes, and (B) a graph depicting the selectivity versus permeance for Polysulfone (PSf)-supported membranes showing the limiting permeance, according to an example embodiment of the present disclosure.

FIG. 3 illustrates the proposed mechanism for grafting the sulfanilic diazonium salt onto GO, according to an example embodiment of the present disclosure.

FIG. 4 shows a schematic of the phase inversion process for the fabrication of PES and PES-SGO membranes, according to an example embodiment of the present disclosure.

FIG. 5 illustrates the testing setup for the vacuum-based air-dehumidification performance analysis, according to an example embodiment of the present disclosure.

FIG. 6 illustrates graphs of carbon and oxygen high-resolution XPS scans deconvoluted for GO, according to an example embodiment of the present disclosure.

FIG. 7 illustrates graphs of carbon, oxygen, nitrogen, and sulfur high-resolution XPS scans deconvoluted for SGO, according to an example embodiment of the present disclosure.

FIG. 8 illustrates graphs of the FT-IR spectrum of GO and SGO, according to an example embodiment of the present disclosure.

FIG. 9 illustrates a graph of XRD analysis on GO, SGO, and sulfonated-reduced GO, according to an example embodiment of the present disclosure.

FIGS. 10A-10F illustrate a surface SEM images of MF PES-SGO MMM containing (A) 0 wt. % SGO, (B) 0.10 wt. % SGO, (C) 0.20 wt. % SGO, and a surface SEM imaging of UF PES-SGO MMM containing (D) 0 wt. % SGO, (E) 0.10 wt. % SGO, and (F) containing 0.20 wt. % SGO, according to an example embodiment of the present disclosure.

FIGS. 11A-11F illustrate cross-section SEM imaging of MF PES-SGO MMM containing (A) 0 wt. % SGO, (B) 0.10 wt. % SGO, and (C) 0.20 wt. % SGO, and (D) cross-section SEM imaging of UF PES-SGO MMM containing (D) 0 wt. % SGO, (E) 0.10 wt. % SGO, and (F) 0.20 wt. % SGO, according to an example embodiment of the present disclosure.

FIG. 12 illustrates a graph of the root-square mean roughness results of PES-SGO MMM, according to an example embodiment of the present disclosure.

FIGS. 13A-13H illustrate 2D AFM images of MF PES MMM containing (A) 0 wt. % SGO and (B) 0.20 wt. % SGO, 2D AFM images of a UF PES-SGO MMM containing (C) 0 wt. % SGO, (D) 0.20 wt. % SGO, 3D AFM images of MF PES-SGO MMM containing (E) 0 wt. % SGO and (F) 0.20 wt. % SGO, 3D AFM images of UF PES-SGO MMM containing (G) 0 wt. % SGO, and (H) 0.20 wt. % SGO, according to an example embodiment of the present disclosure.

FIG. 14 illustrates a graph showing the contact angle analysis for variants of GO, according to an example embodiment of the present disclosure.

FIG. 15 illustrates a graph showing the contact angle analysis for PES-SGO MMM, according to an example embodiment of the present disclosure.

FIGS. 16A-16F illustrate the contact angle images for MF PES-SGO MMM containing (A) 0 wt. % SGO, (B) 0.10 wt. % SGO, (C) 0.20 wt. % SGO, and the contact angle images for UF PES-SGO MMM containing (F) 0 wt. % SGO, (E) 0.10 wt. % SGO, and (F) 0.20 wt. % SGO, according to an example embodiment of the present disclosure.

FIG. 17 illustrates a graph of the water vapor permeance of various PES membranes, according to an example embodiment of the present disclosure.

The reader will appreciate the foregoing details, as well as others, upon considering the following detailed description of certain non-limiting embodiments of the present disclosure.

### DETAILED DESCRIPTION

The present disclosure is generally related to PES membranes and methods of manufacture and use. In an embodiment, a PES MMM is provided by including a small fraction of SGO to enhance the porosity and hydrophilicity and WVP of the PES membrane, such as to reach approximately 25,000 which is about an 85% increase in WVP of the unfilled PES membrane. This very high WVP of PES support should enable meeting the WVP target for energy-efficient membrane-based air-cooling applications.

GO has unique characteristics that make it an attractive material for membrane applications. Its high surface area, hydrophilicity, and microporosity allow for enhanced water permeability and selectivity. However, GO's high production cost and limited scalability have hindered its widespread use in commercial membrane applications. To address this issue, researchers have explored using GO as a fine additive to improve matrix properties, resulting in successful incorporation into various membrane types and increased selectivity. One promising strategy for enhancing GO's performance in membranes is sulfonation. Sulfonation of GO introduces —SO₃H groups onto the surface of GO, which enhances the membrane's hydrophilicity and compatibility with the composite. This results in improved performance for water separation applications.

To test the improvement of the hydrophilicity on the incorporation of SGO into the membrane, first GO is synthesized using Tour's method, which was sulfonated to create SGO. The obtained SGO was characterized by Fourier-transform infrared spectroscopy (FTIR), X-ray diffraction (XRD), Brunauer-Emmett-Teller (BET), atomic force microscope (AFM), scanning electron microscopy (SEM) and X-ray photoelectron spectroscopy (XPS). The synthesized SGO was then incorporated into MF and UF PES using a simple solution casting method. The resulting PES-SGO MMM were characterized by SEM, contact angle measurement, and water vapor permeance measurement. The effect of SGO loading on the membrane performance was investigated by varying the SGO loading from 0.05 to 1 wt. %. The results showed that the incorporation of SGO significantly enhanced the hydrophilicity of the support membrane, with the contact angle decreasing from ˜70° to 50° for both membranes and the permeance increasing to 25,000 GPU. This improvement is attributed to the hydrophilic nature of SGO and its strong interaction with the PES matrix, which enhances the compatibility between the SGO and PES. The results provide a promising approach for improving the performance of PES-based membranes by incorporating SGO, which could have important applications in various fields such as gas separation applications.

However, a key limiting factor for the performance of composite membranes lies in the support membrane. Porous polymeric and inorganic substrates are the most common. Table 1 summarizes the performance of the common air-dehumidification membrane support.

TABLE 1
Performance of Porous Support for
Air Dehumidification Applications

| | | | Water |
|---|---|---|---|
| | Membrane | WVP | Permeability |
| Polymer | type | (GPU) | (Barrer) |
| Polyacrylonitrile (PAN) | MF/UF | 6541-8906 | 300 |
| Polysulfone (PSF) | MF/UF/NF | 550-7000 | 2000 |
| Polyamide (PA) | RO NF, MF/UF | | 275 |
| Polyimide (PI) | UF | 3320 | 640 |
| Polyvinyl acetate (PVA) | UF/NF | | 19 |
| Polyether sulfone (PES) | MF/UF | 7000 | 2620 |
| Nickel | | >20000 | |
| Al₂O₃ | | >20000 | |

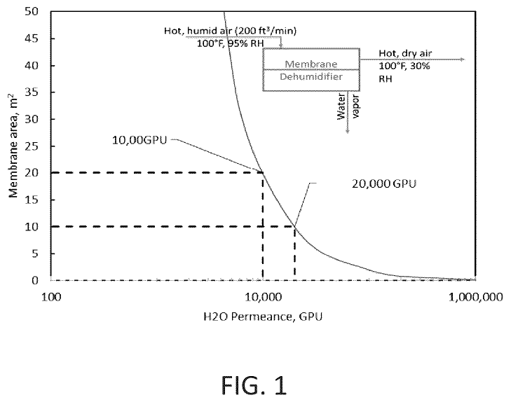

Some of the most common polymeric materials of choice include PES, polysulfone (PSf), polyacrylonitrile (PAN), and polyvinyl difluoride (PVDF). PS and PES are often favored due to the ease of fabricating a composite membrane via coating. The WVP of the support membranes tends to stay low, with PAN having the highest permeance around 9000 GPUs. However, as seen in FIG. 1, the support membrane must have a high WVP, favorably more than 20000 GPU to make commercially viable air-dehumidification membranes.

The PES and PSf are chemically similar, but due to an increased presence of ether and sulfone functional groups, PES tends to have a slightly higher WVP. PES and PSf are mechanically stable due to the bulkiness of the molecules; these make the molecule more rigid and stiff, leading to a lower WVP. On the other hand, other polymers such as PAN are constructed of more flexible monomers of (CH2-CH—(CN)). in a linear design, which in return has a WVP of up to 9000 GPUs, which makes it a great candidate as a support. However, the WVP still does not meet the requirements, where commercially viable air-dehumidification membranes for air cooling applications with a membrane area of 10 m² would be sufficient for a 3-ton cool unit.

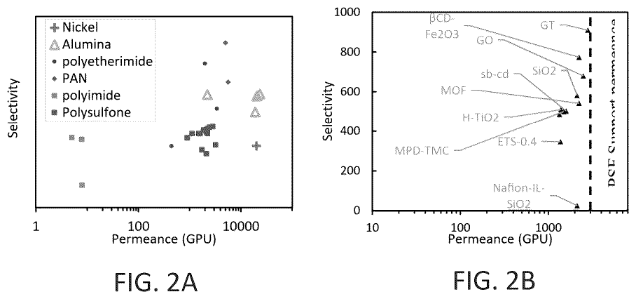

Other materials, especially nickel and alumina-based supports, tend to fare better, as shown in FIG. 2A, where permeances greater than 20000 GPU can be observed. However, when discussing the economical aspect of materials, the average price of 1 m² of alumina-based supports ranges from $500-3000, compared to $20-200 for polymeric membranes.

On the other hand, FIG. 2B shows composite membranes fabricated on PSf support. A key observation is that despite any modification to the membrane, the overall permeance can never exceed the permeance of the support. Therefore, the challenge is to produce support for thin film composite membranes (TFC) with a high WVP.

In one embodiment, MF and UF PES-SGO membranes are fabricated. Additionally, three grades of commercial UF PES membranes (MT, ST, and MK) were obtained. The MT membrane has a molecular weight cut-off (MWCO) of 5,000, the ST membrane has MWCO of 10,000, and the MK membrane has MWCO of 30,000.

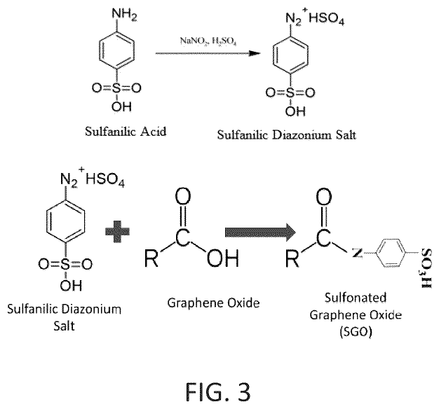

The synthesis of GO is shown in FIG. 3. To synthesize the GO, Tour's method is used. 1 gram of graphite flakes was added to a 120/13.5 mL mixture of concentrated sulfuric acid and phosphoric acid. The mixture was stirred till the temperature is equilibrated at 40° C. Potassium permanganate is added sparingly over the one hour. The reaction was carried at 50° C. for 12 h. Then, the GO solution was cooled to room temperature before being quenched in 200 mL of deionized water kept at 5° C. Then, hydrogen peroxide is added dropwise until the color of the solution changes to yellow to light brown. Next, the mixture is washed twice with 30% hydrochloric acid, two times with 30% ethanol, and with DI water, followed by centrifugation at 4000 RPM for 4 hours, and repeated washing with water until the pH of the supernatant reaches ˜7. The solution is freeze-dried for use in the preparation of SGO.

The prepared GO is sulfonated by grafting sulfone groups to enhance its hydrophilicity. The sulfonation was carried out by reacting diazonium salt of sulfanilic acid and sodium nitrate. GO of 6 mg/mL in DI water was dissolved with 1 g sodium nitrite for 280 mg GO with 800 mg of sulfanilic acid. The mixture is heated up to 60° C. and left for a reaction for 12 hours. After the reaction is complete, it is left to cool down to room temperature, and thorough washing with DI water and centrifugation is done until the pH of the solution is above 6. The resultant SGO is hydrophilic; therefore, large dilute quantities are freeze-dried and used.

X-ray photoelectron spectroscopy was used to identify the elemental components present on the surface of GO and SGO. Survey scans of low resolution were conducted to obtain the atomic quantification. In contrast, high-resolution scans of carbon, oxygen, nitrogen and sulfur were conducted to study the elemental structure of the respective materials. XRD is used to analyze the stacking properties, d-spacing, and crystallite size, measured in the 2θ range of 5 to 60°. The interplanar distance (d), known as d-spacing between the sheets, is calculated by Bragg's law. The interplanar distance of GO and SGO was calculated using Scherrer's equation. The hydrophilicity of GO and SGO was assessed by measuring the water contact angle (WCA). GO and SGO films were prepared by vacuum filtration of GO/SGO aqueous dispersion over a 0.45 μm nylon membrane to make 25 μm thick membranes. A water droplet was placed on the surface of 1×3 cm membrane, and the static contact angle was recorded.

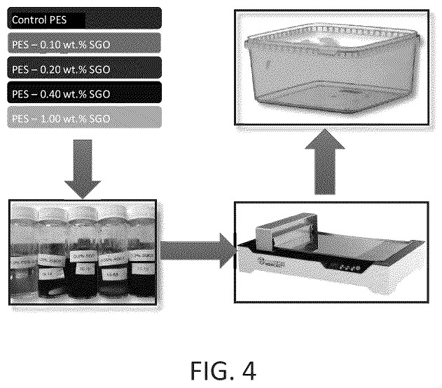

The fabrication method of the MF and UF PES membrane is shown in FIG. 4. Prior to membrane fabrication PES and PVP powders were dried for 4 h at 80° C. PES MF membranes were fabricated by dissolving 15% PES and 5% PVP in DMAc, while PES UF membranes were fabricated by dissolving 17.5% PES and 2.5% PVP in DMAc. The solution was cast on a glass slide using a 150-μm casting knife and an automated membrane casting machine, followed by coagulation in water bath. The fabricated membranes were stored in DI with daily water change for 4 days. The PES MMM were fabricated similarly with incorporating the required amount of SGO in the dope solution to reach a loading of 0, 0.10, 0.20 and 0.40 and 1.00 wt. % of S-GO, relative to PES. The SGO was homogenously dispersed in the PES/PVP solution in DMAc through bath sonication for 30 min followed by degassing for 15 min.

Field Emission Scanning Electron Microscopy was used to characterize the membrane surface and cross-sectional morphology. The analysis was conducted under a low vacuum of 30 Pa, whilst using a spot size of 10 and a voltage of 10 KV. For surface analysis, no pre-treatment or coating was done. Whereas, for cross-sectional analysis, membranes were cryo-fractured by wetting the membrane in water and dipping into liquid nitrogen, followed by rapid cracking with a tweezer. The membrane hydrophilicity was assessed by measuring the WCA). A water droplet was placed on the surface of 1×3 cm membrane strip and the static contact angle was measured. Atomic Force Microscopy (“AFM”) was utilized to investigate the surface topography of the membrane. The surface's roughness resonates with the membrane's hydrophilic properties and fouling tendencies. Tapping mode was utilized, where small membranes samples were taped on a microscope slide. The root-square mean roughness and maximum roughness were studied to investigate the topography of the membranes.

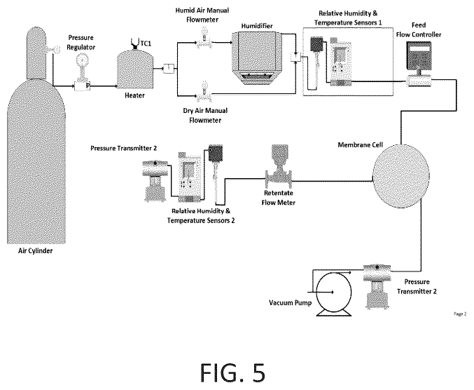

The air dehumidification performance of the membrane was tested at specific relative humidity with selected pressures of the inlet feed. The setup consists of an air dehumidification module with a humidity controller. The inlet air is humidified and enters the membrane cell. The membrane cell rejects the dry air, and the water vapor passes through the permeate side, which is helped by the vacuum pump, as shown in FIG. 5. The water permeance in the membrane can be calculated by the difference in the relative humidity in and permeate, respective to the inlet water content. Permeance (J), which has the units of mol/(m²sPa), can be calculated by J_{H2O}=(N_{H2O}/(A(ΔP_{H2O})Im)).

Using the chemical composition by XPS, as seen in Table 2, it is determined that the GO synthesized via Tour's route had a higher Oxygen/carbon ratio than Hummer's GO, initially indicating more oxidation of the graphite flakes. Higher oxidation and presence of oxygen would indicate a higher concentration of oxygen-based functionality, which consequently should increase the hydrophilicity. Moreover, there is a 0.3% increase in the sulfur concentration of Sulfonated GO, which would initially indicate the presence of sulfonic groups being successfully grafted onto the GO skeleton.

TABLE 2
Atomic Composition of GO and SGO Determined by XPS

| | Atomic Composition (%) | | |
|---|---|---|---|
| Compound | Carbon | Oxygen | Sulfur |
| GO Hummer | 65.1 | 34.9 | 0.0 |
| GO (Tour) | 63.6 | 36.4 | 0.0 |
| Sulfonated GO | 67.4 | 32.3 | 0.3 |

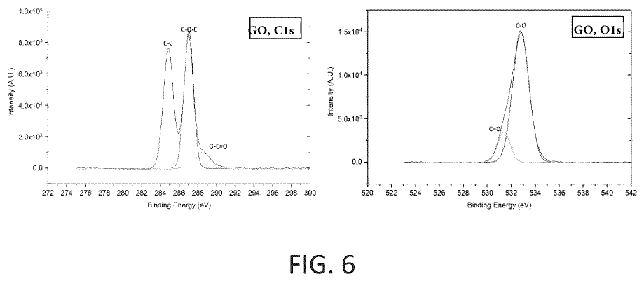

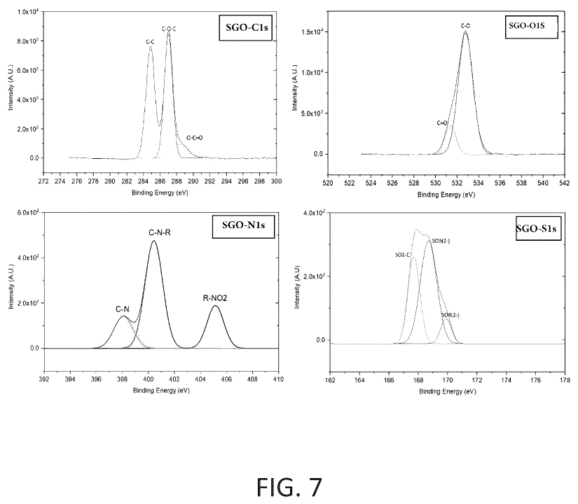

The high-resolution XPS scans of carbon and oxygen provided in FIGS. 6 and 7 show the presence of carbon-carbon (C—C) bonds at 284.8 eV and two variants of oxygen attached to carbon in the form of C—O—C at 286.7 eV and O—C—O at 288.5 eV. Preliminarily, these show the successful synthesis of GO from graphite due to the abundance of oxygen-based functional groups attached to the carbon. Moreover, two specific groups of epoxy and carboxylic functional groups can be noted. For the oxygen spectra, oxygen attached to carbon in the form of C═O and C—O are visible at 531.4 eV and 533 eV, respectively. Additionally, this allows the estimation that a hydroxy and carbonyl group are also present.

Via the high-resolution nitrogen scan of FIG. 7, nitrogen attached to carbon as an amine group can be observed at 398 eV. In contrast, nitrogen attached to a phenyl group can be observed at 400.5 eV. Lastly, the presence of the nitrite group is shown at ˜405 eV. The presence of the nitrile and amine groups show the residue of sodium nitrite and sulfanilic acid used in the synthesis reaction. However, the nitrogen attached to the phenyl ring indicates that GO was successfully sulfonated. The high-resolution sulfur scan does not confirm the presence of sulfanilic acid in the sulfonated GO as sulfanilic acid is grafted onto the carbon ring.

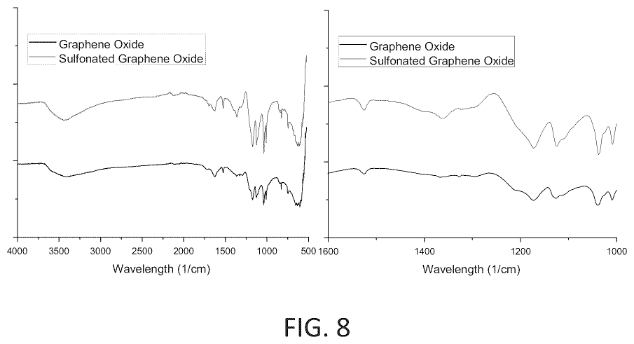

Through the FTIR, the presence of oxygen-based functional groups was confirmed. For GO a large stretch of OH bending was present at the 3550-3220 cm⁻¹ mark, with presence of C═O stretching around 1725-1705 cm⁻¹. Moreover, C—O stretching was also present around 1150 cm⁻¹ showing the aliphatic ester group's functionality. Along with the same functional groups present in GO, the FT-IR confirmed the presence of the sulfone group attached to the graphene oxide's skeleton as a peak at the wavelength 1350 cm⁻¹ can be observed in FIG. 8.

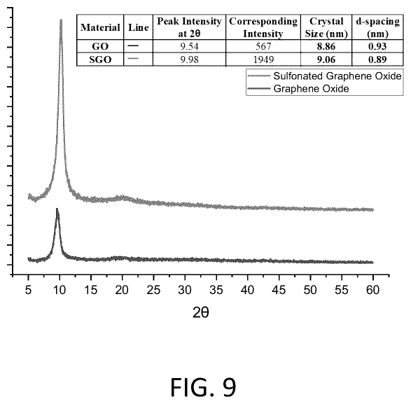

The XRD pattern of GO in FIG. 9 shows a peak at 2θ=9.54, whereas SGO showed a slight peak shift at 2θ=9.98, and 10.18. SGO shows an increase in peak height and narrowing of the peak, suggesting an increase in crystallite size. The computed results tabulated in the figure below show that the d-spacing has very slight to no change during sulfonation. The d-spacing of GO was 0.93 nm (9.3 Å), whereas, for SGO and SRGO, the d-spacing values were 0.89 nm (8.9 Å) and 0.87 nm (8.7 Å), respectively. Moreover, using Scherrer's equation, the crystallite size of GO increases from 8.86 nm to 9.06 nm, determining that the grafting of the sulfanilic salt has been done successfully.

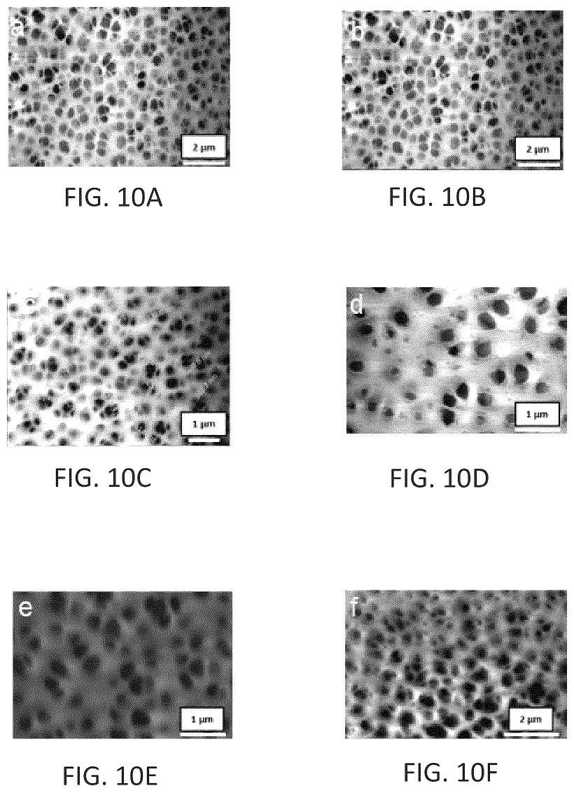

The SEM analysis of the membrane surface reveals the MF membranes' higher porosity and lower pore size than the UF membranes. As seen in FIG. 10, the porosity and pore size increase with SGO loading. These changes are attributed to the effect of SGO on the solvent exchange rate during the coagulation step. FIGS. 10A-10C depicts surface SEM images of PES-SGO MF membranes. In FIG. 10A, the membrane contains 0 wt. % SGO. In FIG. 10B, the membrane contains 0.10 wt. % SGO. In FIG. 10C, the membrane contains 0.20 wt. % SGO. FIGS. 10D to 10F depict surface SEM images of PES-SGO UF membranes. In FIG. 10D, the membrane contains 0 wt. % SGO. In FIG. 10E, 0.10 wt. % SGO. In FIG. 10F, the membrane contains 0.20 wt. % SGO.

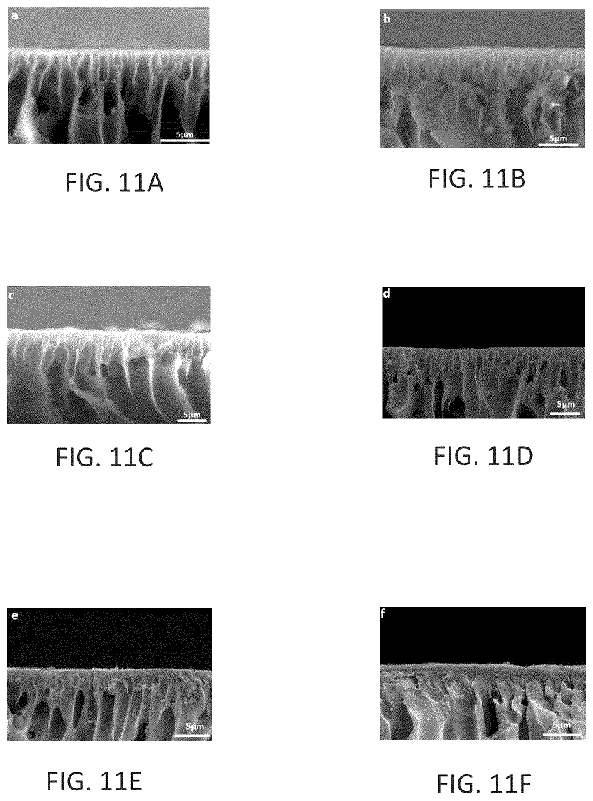

The cross-sectional images shown in FIGS. 11A-11F reveal the channels and active layer of the polyether sulfone mixed matrix membranes. Although the channel structure is not affected by the SGO loading, an increase in the thickness of the dense layer is observed with the SGO addition. Notably, the dense layer is more pronounced in the 17.5 wt. % PES MMM. FIGS. 11A to 11C depict cross-section SEM imaging of 15.0 wt. % PES-SGO MMM. In FIG. 11A, the membrane contains only PES as a control. In FIG. 11B, the membrane comprises 0.10 wt. % SGO. In FIG. 11C, the membrane comprises 0.20 wt. % SGO. FIGS. 11D to 11F depict cross-section SEM imaging of 17.50 wt. % PES-SGO MMM. In FIG. 11D, the membrane contains only PES as a control. In FIG. 11E, the membrane comprises 0.10 wt. % SGO. In FIG. 11F, the membrane comprises 0.20 wt. % SGO.

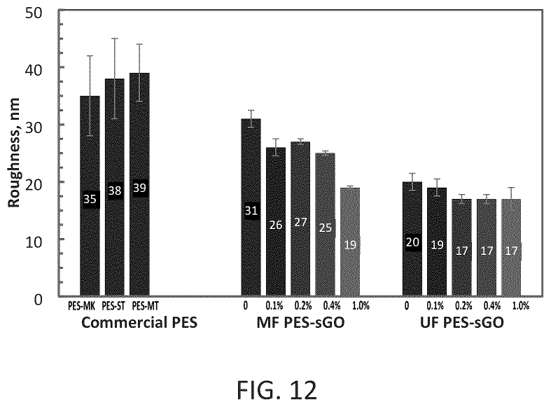

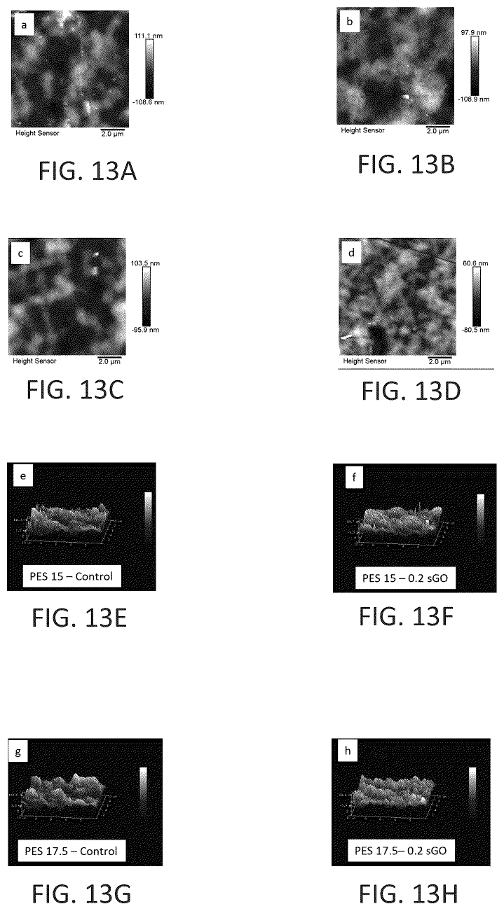

The topography study of AFM reveals a decrease in roughness with SGO loading. This could be corroborated by the thickening of the dense layer, as seen in the morphological studies through the SEM. As can be seen in FIGS. 12 and 13, the commercial PES UF membranes of Snyder Filtration have higher roughness that ranges between 35 to 40 nm, compared to our control MF and UF membranes, which have a roughness of 31 and 20 nm, respectively. The higher roughness increases the fouling tendency. On the other hand, the MMMs with SGO have a smoother topography with roughness decreasing from 31 nm for the control MF to 19 nm for the MF PES-SGO containing 1% SGO. On the other hand, the roughness of the UF membranes is less affected by the SGO content. This would indicate that the dense layer formation in the MF MMM is not as pronounced until a significantly higher concentration of SGO is added. On the other hand, a leveling-off effect can be observed in the UF PES MMM, where a steady decrease can be observed. However, a quick leveling-off effect can be seen after 0.2 wt. % SGO addition, indicating the dense layer thickens significantly enough. This can be corroborated in the SEM images in FIG. 11, suggesting that any SGO loading higher than 0.20 wt. % may not impact the roughness of the PES membrane.

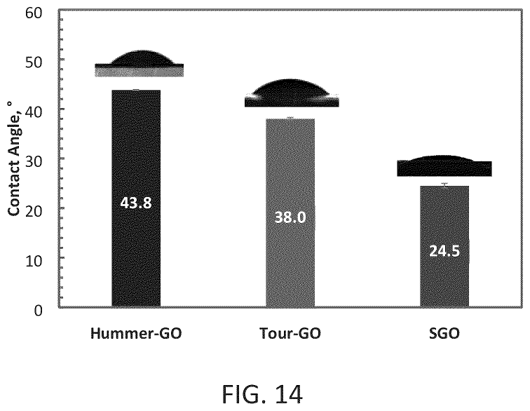

Tour's higher oxygen atomic concentration makes it more hydrophilic, as seen in FIG. 14. The GO synthesized via Tour's method exhibits a lower WCA of 38°. On the other hand, the WCA of SGO is 24.5°, an improvement of 13.5°. This characteristically shows an increase in hydrophilicity and confirms the successful grafting of sulfone groups. The sulfonation of GO allows hydroxyl groups to be replaced with more hydrophilic sulfone groups, which helps increase the hydrophilicity of the SGO.

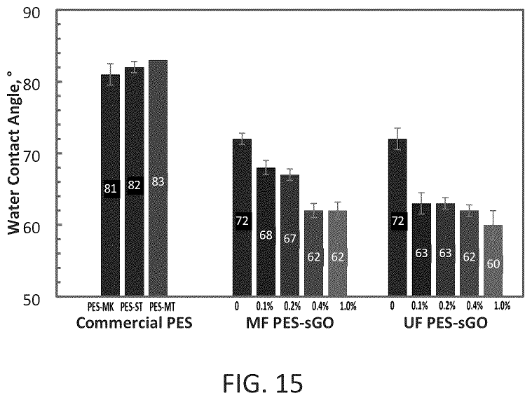

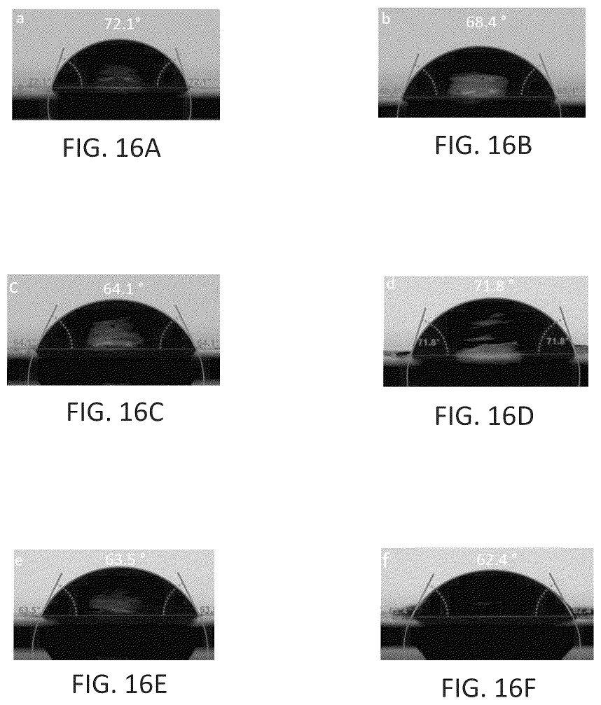

The control MF and UF PES membranes exhibit WCA of 72°, significantly more hydrophilic than commercial PES samples, WXA of 81° to 83°. A higher contact angle can indicate the resistance of water vapor adsorbing onto the membrane surface. The addition of SGO into the PES matrix showed a trend of a decreasing WCA, as seen in FIG. 15 and FIGS. 16A-16F. FIGS. 16A to 16C depict WCA images of MF PES-SGO MMM. In FIG. 16A, the membrane contains only PES as a control. In FIG. 16B, the membrane contains 0.10 wt. % SGO. In FIG. 16C, the membrane contains 0.20 wt. % SGO. FIGS. 16D to 16F depict cross-section SEM imaging of UF PES-SGO MMM. In FIG. 16D, the membrane contains only PES as a control. In FIG. 16E, the membrane contains 0.10 wt. % SGO. In FIG. 16F, the membrane contains 0.20 wt. % SGO.

This can be explained by the SGO's water affinity during the phase inversion fabrication process. The significant difference in the hydrophilic properties between the SGO and PES results in SGO forming a dense layer at the surface of the membrane. Therefore, a larger cluster of SGO is present with a higher loading, reducing the contact angle further. The significant effect of the increase in hydrophilicity occurs after adding 0.1 to 0.4 wt. % of SGO in the MMM of both MF PES-SGO and UF PES MMMs. For the MF PES-SGO MMM, the mean WCA decreases from 72° to 62° after adding 0.4 wt. % MMM and then levels off, indicating a higher loading would not affect the hydrophilicity of the membranes. Moreover, for the UF PES-SGO MMM, a similar trend can be observed only after the addition of 0.1-0.2 wt. % of SGO. This may be seen before, where there is no more significant effect of the dense layer with additional loadings. The mean WCA continues declining to 60° for 1.0 wt. % SGO loading, there is still a significant overlap with error bars, indicating higher loadings may not be as effective.

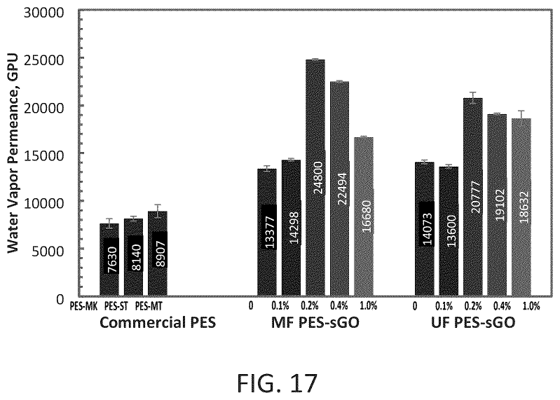

The in-house fabricated MF and UF control membranes initially show results similar to those of literature and commercial UF PES membranes. The addition of SGO helps increase the permeance multi-fold to where 0.20 and 0.40 wt. % concentrations yield WVP of ˜24000 GPU, similar to that of nickel and alumina-based substrates and meeting the consequent target of greater than 20000 GPUs. The best-performing SGO-PES membranes are those of 0.20 and 0.40 wt. % membranes, as seen in the figure below. Generally, for each concentration, MF PES MMMs had a higher water vapor permeance. This is expected as the MF membranes would have larger pore sizes and porosity, and the overall free space would allow more water vapor to permeate. On that note, looking at FIG. 17, it is abundantly clear that porosity and the free space available in the membrane play a greater factor for water vapor to permeate compared to its intramolecular interactions with water vapor, as permeance of air and water vapor both increase proportionally. Although the selectivity values of the PES-MMM are negligible, not a lot of emphasis can be placed on them.

PES-SGO MMM can viably replace Alumina and Nickel substrates commonly used in high-performance thin film composite membranes (TFC), especially in hydrophilic applications where water/water vapor is permeated. The permeance of water vapor is highest for 0.2-0.4 wt. % SGO membranes, where higher and lower concentrations of SGO tend to decrease water vapor permeance. At 0.20 and 0.40 wt. % loadings, consequently, the water contact angle in the wettability study also levels off, showing greater loadings do not greatly affect the hydrophilicity of the surface. Overall, with water vapor permeance greater than 24,000, the membranes of 0.20 and 0.40 wt. % SGO in both UF and MF PES matrices can replace Alumina and Nickel in composite studies of membranes.

The disclosed technology relates to, for example, a high-performance membrane for air dehumidification, which has the potential to be used in a variety of commercial and industrial applications. The membrane can be incorporated into HVAC systems in residential, commercial, and industrial buildings, where it can help to reduce energy consumption and improve indoor air quality by removing moisture from the air. The membrane can also be used in food and beverage production to control humidity levels, prevent spoilage, and maintain product quality. Additionally, the membrane can be used in pharmaceutical manufacturing to help maintain precise environmental conditions and prevent moisture-related damage to sensitive products. It is contemplated that the present technology can be used to create a range of commercial products and services that help improve energy efficiency, product quality, and process control across various industries.

It should be understood that various changes and modifications to the presently preferred embodiments described herein will be apparent to those skilled in the art. Such changes and modifications can be made without departing from the spirit and scope of the present subject matter and without diminishing its intended advantages. It is, therefore, intended that such changes and modifications be covered by the appended claims.

The invention is claimed as follows:

1. A process to fabricate a polyethersulfone membranes comprising:
providing polyethersulfone and sulfonated graphene oxide;
forming a solution including polyethersulfone and sulfonated graphene oxide; and
processing the solution to provide the polyethersulfone membrane.

2. The process of claim 1, further comprising reacting sulfanilic diazonium salt and graphene oxide to produce sulfonated graphene oxide.

3. The process of claim 1, further comprising dispersing sulfonated graphene oxide in the solution through sonication.

4. The process of claim 1, further comprising dispersing sulfonated graphene oxide in the solution through degassing.

5. The process of claim 1, wherein the solution further includes polyvinylpyrrolidone and dimythylacetamide.

6. The process of claim 1, wherein processing the solution by casting to provide the polyethersulfone membrane.

7. A polyethersulfone membrane, comprising polyethersulfone and sulfonated graphene oxide.
